(19) United States
(12) Patent Application Publication
(10) Pub. No.: US 2026/0152054 A1
(43) Pub. Date: Jun. 4, 2026

(54) ELECTRIC MACHINE GENERATING ELECTRICAL ENERGY AND FOR GENERATING A TORQUE, AND DRIVE UNIT FOR A HYBRID VEHICLE

(71) Applicant: Schaeffler Technologies AG & Co. KG, Herzogenaurach (DE)

(72) Inventors: Alexander VOIT, Sinzheim (DE); Dominik HANS, Muggensturm (DE); Steffen LEHMANN, Ettlingen (DE)

(73) Assignee: Schaeffler Technologies AG & Co. KG, Herzogenaurach (DE)

(21) Appl. No.: 18/705,642

(22) PCT Filed: Sep. 19, 2022
(86) PCT No.: PCT/DE2022/100695

§ 371 Date: Apr. 29, 2024

(30) Foreign Application Priority Data
Nov. 5, 2021 (DE) 10 2021 128 777.4

(51) Int. Cl. B60K 6/38; B60K 6/24; B60K 6/26; B60K 6/405

(52) U.S. Cl. CPC B60K 6/38; B60K 6/24; B60K 6/26; B60K 6/405

(57) ABSTRACT

An electric machine for generating electrical energy and for generating a torque for a hybrid vehicle, includes a housing having an axial opening for installing a stator and a rotor and having an outer housing wall part which delimits the electric machine relative to the environment, a torsional vibration damper for damping torsional vibrations of an internal combustion engine, and a torque-switching safety clutch) for preventing component-damaging differences in torque between the electric machine and the engine. The electric machine has a sealing device that seals the axial opening of the housing and subdivides the interior of the housing into two sections of space in the axial direction. The torsional vibration damper is arranged in one of the sections and the safety clutch is arranged in the other section. A drive unit for a hybrid vehicle is also provided.

### CROSS-REFERENCE TO RELATED APPLICATIONS

This application is the U.S. National Phase of PCT Appln. No. PCT/DE 2022/100695, filed Sep. 19, 2022, which claims priority to German Patent Application No. 10 2021 128 777.4, filed Nov. 5, 2021, the entire disclosures of which are incorporated by reference herein.

### TECHNICAL FIELD

The disclosure relates to an electric machine for generating electrical energy and for generating torque for a hybrid vehicle and a drive unit for a hybrid vehicle.

In other words, the present disclosure relates to a device or an electric machine and a drive unit for a hybrid vehicle, such as a dedicated hybrid transmission (DHT), having one or two electric machines for use in a motor vehicle.

### BACKGROUND

From the unpublished German patent application with the official file number 10 2020 123 116.4, a transmission with two electric machines is known, as shown in FIG. 1 and FIG. 2.

As shown in FIG. 1, a first electric machine 1 is connected as a generator directly to a crankshaft 101 of a combustion motor 100 or an internal combustion engine 100 (only indicated with reference signs).

In this case, a second electric machine 200 serves as a traction machine or driving machine.

An engine housing 104 or a housing 104 of the internal combustion engine 100 and a transmission housing 2 or a housing 2 of the first electric machine 1 are screwed together and form a parting plane T.

The combustion motor 100 or the internal combustion engine 100 is sealed via a crankshaft seal 105 or a radial shaft seal 105.

FIG. 2 shows an enlarged section of FIG. 1.

A stator 36 of the first electric machine 1 is connected to the transmission housing 2 or the housing 2 of the electric machine 1 by means of a stator carrier 37, for example using screws S.

A coolant or cooling water channel 38 or a cooling channel 38 is limited by the transmission housing or by the housing 2 of the electric machine 1 and the stator carrier 37.

A rotor 32 of the first electric machine 1 is connected to the crankshaft 101 by a rotor carrier 33 and screws S.

A space A or a first spatial section A, in which the first electric machine 1 is located, is dry and separated from a wet or oil space B of the transmission or from a second spatial section B by the transmission housing 2 or by the housing 2.

A transmission with two electric machines is known from the unpublished German patent application with the official file number 10 2021 108 127.0, as shown in FIG. 3.

As shown in FIG. 3, a rotor 32 of a first electric machine 1 is connected on one side to a crankshaft 101 of an internal combustion engine 100 (only indicated with reference signs) via a rotor carrier 33, screws S, a so-called flexplate 102 or a flexible disc part 102 and screws S.

On another side axially opposite the connection of the rotor 32 to the crankshaft 101, the rotor carrier 33 is supported by a roller bearing 35 or by a bearing 35.

The space A or the first spatial section A of the first electric machine 1 is dry and separated from a wet or oil chamber B of the transmission or from a second chamber section B by the transmission housing 104 or by the housing 104 of the internal combustion engine 100 and a radial shaft seal 53.

It has been found that in the previously stated prior art, the space or the spatial section A between the combustion motor 100 or the internal combustion engine 100 and the transmission or the housing 2 of the electric machine 1 is difficult to seal and a waterproof insulation of the stator 36 of the first electric machine 1 is difficult and complex.

More precisely, in many cases it is very difficult to design the parting plane T of the engine housing 104 or the housing 104 of the internal combustion engine 100 and the transmission housing 2 or the housing 2 of the electric machine 1 in such a way that a closed sealing surface is created.

It cannot therefore be prevented that, for example, moisture penetrates into the space A or into the first spatial section A when crossing water.

A design of the stator 36 of the first electric machine 1 in such a way that it is insulated against water in all cases and there is no risk of a short circuit would be possible in principle, but is very complex in terms of production technology.

A direct screwing of the rotor 32 of the first electric machine 1 to the crankshaft 101 would eliminate the need for complete testing of the first electric machine 1 before assembly of the transmission or the electric machine 1 to the combustion motor 100 or to the internal combustion engine 100, since the rotor 32 is part of the crankshaft 101 and is only combined with the stator 36 during assembly. However, an adjustment of the first electric machine 1, such as an adjustment of an air gap between the stator 36 and the rotor 32, must then be carried out during or after the assembly of the transmission/housing 2 of the electric machine 1 to the combustion motor 100/internal combustion engine 100, which is not always desirable.

A design of a known transmission input with a toothed transmission input shaft and the first electric machine 1 in an oil chamber would require an upstream torsional vibration damper in a serial drive due to the play of a toothed spline and would also be costly and require a lot of installation space.

In light of the above statements, it is also known that a serial/parallel hybrid drive unit with an internal combustion engine, in addition to a torsional vibration damper, also has an additional element, e.g. in the form of a slip clutch, required to avoid impermissibly high loads on the hybrid drive unit.

Solutions exist in which a torsional vibration damper and a slip clutch are arranged inside a rotor of an electric machine. This shows again that, for example when crossing water, moisture penetrates into the space A or into the first spatial section A with the electric machines.

### SUMMARY

Accordingly, it is the object of the present disclosure to eliminate the aforementioned problems in the prior art and to provide an improved device or electric machine and an improved drive unit for a hybrid vehicle with one or two electric machines for use in a motor vehicle.

According to the disclosure, this object is achieved by one or more of the features disclosed herein. Further advantageous developments are described below and in the claims.

In a first aspect, an electric machine for generating electrical energy and for generating a torque for a hybrid vehicle has a housing having an axial opening for installing a stator and a rotor device and having at least one outer housing wall part which delimits the electric machine relative to the environment.

The electric machine further comprises a stator device which is arranged inside the housing.

In addition, the electric machine comprises a rotor device for connection to an internal combustion engine, such that rotational energy of the internal combustion engine can be converted into electrical energy or rotational energy of the electric machine can be conveyed to the internal combustion engine or rotational energy of the electric machine can be added to the rotational energy of the internal combustion engine.

Furthermore, the electric machine has a torsional vibration damper for damping torsional vibrations of an internal combustion engine and a torque-switching safety clutch for preventing component-damaging torque differences between the electric machine and an internal combustion engine.

The electric machine also has a sealing device that seals the axial opening of the housing and subdivides the interior of the housing into two spatial sections in the axial direction, such that a crankshaft of an internal combustion engine can be connected to the rotor device in a first spatial section or in a dry space and the stator device is arranged in a second spatial section or in an oil space. Sealing the axial opening of the housing prevents water from penetrating into the second spatial section, such that the stator device or its stator cannot be damaged. This is because the sealing device protects the stator or the stator device from water and dirt. On the other hand, due to the sealing device, sealing of the stator device of the electric machine is possible with simple effort. Furthermore, with the help of the sealing device, the electric machine can be tested in the factory before assembly with an internal combustion engine. As a result, an electric machine with a housing can be created which can be tested with an internal combustion engine before assembly and which is protected against the ingress of water and/or dirt, even though the electric machine has not yet been assembled with an internal combustion engine or its housing. In other words, a first and second spatial section or a drying space and oil space are sealed against each other using the sealing device. The seal or the sealing device contributes to ensuring that, on the one hand, no water enters the electric machine and, on the other hand, no oil escapes from the electric machine.

In addition, the torsional vibration damper is arranged in one of the two spatial sections and the safety clutch is arranged in the other of the two spatial sections. Described in more detail, the torsional vibration damper can be arranged in the second spatial section and the safety clutch in the first spatial section. The torsional vibration damper can be protected against the ingress of water and/or dirt and can be cooled with oil, for example. On the other hand, the safety clutch generally does not require oil cooling and can also be exposed to water and/or dirt. The design of an electric machine presented above enables the safety clutch to be arranged in a dry space or in the first spatial section. The torsional vibration damper can be arranged in an oil space or in the second spatial section. This offers additional advantages in terms of damper service life, as the contact elements within the damper or torsional vibration damper are supplied with lubricant and wear can therefore be reduced.

Furthermore, the sealing device can be arranged within the housing and extend from the at least one outer housing wall part or from a stator support of the stator device towards the rotor device, for example in the radial direction and/or for example to a hub unit of the rotor device. This prevents water and dirt from penetrating between the housing and the rotor device, since the rotor device, like the housing, can be designed to be impermeable as a component and can therefore seal itself.

The sealing device can lie sealingly on the at least one outer housing wall part or on a stator carrier of the stator device and on the rotor device, for example on a hub unit of the rotor device.

The sealing device can be designed in such a way that it can be clamped or expanded between the at least one outer housing wall part and the rotor device or a hub unit of the rotor device. This improves the sealing of the sealing device. The sealing device can also be designed in such a way that it can be spread or clamped or pressed into the housing or into or onto the at least one outer housing wall part. This means that fasteners such as screws or rivets can be dispensed with, which saves weight and simplifies assembly using screws to be attached. Furthermore, the sealing device is arranged in a rotationally rigid manner on at least one outer housing wall part or on the housing.

The sealing device can comprise a radial shaft seal. The smaller their diameter, the better their sealing effect and the less their influence in terms of friction.

The radial shaft seal can be arranged on a sealing surface of a hub unit of the rotor device. This interaction allows optimal sealing.

Furthermore, the sealing device can comprise a shaped sealing element whose course is funnel-shaped. The safety clutch can be arranged within the funnel. A space-saving arrangement can therefore be achieved.

The sealing element can form a receptacle for the housing or for a stator carrier of the stator device at its end, viewed in the radial direction outwards, or at its radially outer end.

Furthermore, the sealing element can be arranged in a rotationally fixed manner on the housing or on a stator carrier of the stator device.

Here, the sealing element can have at least one passage for a screw or a rivet at the radially outer end such that a friction-fitting or form-fitting connection can be created between the sealing element and the housing or a stator carrier of the stator device. The sealing effect can thus be increased and the position of the sealing element can be secured.

In addition, the sealing element can be viewed at its end in the radial direction inwards or can form a receptacle for a radial shaft seal of the sealing device at its radially inner end and can be designed in such a way that the radial shaft seal can be tensioned with a preload force against a sealing surface of a hub unit of the rotor device. The preload force ensures that the radial shaft seal rests securely on the associated sealing surface, which increases the sealing performance.

Furthermore, the sealing element can have a seal which is arranged between a stator carrier of the stator device or between a housing wall part and a sealing element of the sealing device. This means that the sealing performance can also be increased.

Furthermore, the rotor device can have a hub unit to which the torsional vibration damper and the safety clutch are each partially attached. This simplifies pre-assembly and allows vibration damping and overload protection on the rotor device.

Furthermore, the hub unit, together with the sealing device, can seal the axial opening for installing the stator and rotor devices.

The hub unit can also be designed to accommodate a shaft of the electric machine. This means, for example, that space-saving storage can be achieved in conjunction with the hub unit.

The hub unit can be designed and configured in such a way that it is solid or impermeable in the area of the axis of rotation of the electric machine, extends symmetrically about the axis of rotation and is arranged further inwards in the radial direction than a rotor carrier of the rotor device.

Furthermore, the hub unit can comprise a hollow cylindrical part for receiving a shaft of the electric machine.

The hub unit can also comprise a fully cylindrical part for operative connection to a crankshaft of an internal combustion engine.

The hollow cylindrical part and the fully cylindrical part can be arranged one behind the other in the axial direction.

Furthermore, the hollow cylindrical part can have a receptacle for a needle bearing on its inner surface in order to support forces on a shaft of the electric machine and to enable a relative rotation of the hub unit to this shaft and/or to an axis of rotation of the electric machine.

The fully cylindrical part can have a bearing point on its outer lateral surface for bearing on an inner lateral surface of a crankshaft of an internal combustion engine.

Furthermore, the hub unit can have a sealing surface for a radial shaft seal of the sealing device. The sealing performance of the sealing device can therefore be increased.

The sealing surface can be arranged between a first driving part of the rotor device and a second driving part of the rotor device. Both driving parts can be arranged on the hub unit. In this way, the first driving part can be arranged in the first spatial section and the second driving part in the second spatial section, wherein the two spatial sections are sealed against one another using the sealing device, such that water and dirt cannot get from one spatial section to the other.

In addition, the sealing surface can be formed by a shoulder of the hub unit. This ensures that the sealing surface can be produced in a simple manner.

Furthermore, the hub unit can have a shoulder against which a second driving part of the rotor device rests on one side and a first driving part of the rotor device on the other side, such that a crankshaft of an internal combustion engine can be connected to a rotor carrier of the rotor device via the driving parts and via the hub unit.

The shoulder can project outwards as viewed in the radial direction or can project outwards as viewed from the hub unit in the radial direction. In this way, a sealing surface formed on this can be manufactured in a simple manner.

The shoulder can have multiple through holes, for example extending in the axial direction, in each of which a rivet or a screw can be arranged, which connects the hub unit and/or a first driving part of the rotor device and/or a second driving part of the rotor device to one another in a rotationally fixed manner.

In addition, the rotor device can comprise a first driving part with which the safety clutch is arranged on the rotor device.

The rotor device can also comprise a second driving part with which the torsional vibration damper is arranged on the rotor device.

Furthermore, the safety clutch can comprise an output with which the safety clutch is arranged on a hub unit of the rotor device.

The output can be formed by a first driving part of the rotor device.

In addition, the safety clutch can have an input which is formed by a connecting part with which the safety clutch can be connected to a crankshaft of an internal combustion engine.

The safety clutch can also be designed in such a way that when a certain torque is exceeded, the input and the output can be rotated relative to one another.

In addition, the radial inside of the connecting part can form an input to the torque-switching safety clutch and thus form part of the torque-switching safety clutch.

The connecting part can have at least one internal thread on its radial outside for connection to a crankshaft of an internal combustion engine.

Furthermore, the safety clutch can comprise at least one first friction element which is connected to the first driving part in a rotationally fixed manner.

The safety clutch can also comprise at least one second friction element which is connected to the connecting part in a rotationally fixed manner.

A friction lining can be arranged between the at least one first and second friction element.

Furthermore, the safety clutch can comprise at least one plate spring as an axial energy store in order to apply a normal force to the at least one first and second friction element and/or to a friction lining and thus to generate a definable friction torque.

The safety coupling can also comprise a counterplate and at least one spacer element for axially spacing the counterplate from the connecting part.

At least a first and at least a second friction element, a plate spring and/or a friction lining can be arranged between the counterplate and the connecting part in order to transmit a torque. By specifically selecting the properties and number of friction elements, plate springs and/or a friction lining, the torque at which the safety clutch prevents torque transmission can be adjusted.

In addition, the safety clutch can be designed without or apart from the connecting part in such a way that a rotor of the rotor device has a larger diameter than the safety clutch. In other words, the safety clutch can have a smaller diameter than a rotor of the rotor device. In this design, due to the position of the safety clutch radially below a rotor carrier of the rotor device and when used in the dry space or in the first spatial section, the number of friction linings can be easily increased in order to compensate for the loss of friction torque (due to the reduction of the effective friction radius) by adding additional friction surfaces. As a result, the installation space of the safety clutch does not require any expansion in the radial direction, whereas expansion in the axial direction is easily possible. As a result, a compact design of the electric machine can be achieved.

The torsional vibration damper can comprise at least one compression spring, one input and at least one flange part as an output to a shaft of the electric machine.

The input can be formed by a second driving part of the rotor device.

The at least one compression spring can absorb a torque from the second driving part and convey it to the at least one flange part.

The input of the torsional vibration damper can be arranged on a rotor carrier of the rotor device in a rotationally fixed or torsion-proof manner and/or in a torque-locking manner by means of one or multiple dowel pins.

The torsional vibration damper can further comprise a counter disk part, at least one friction ring part, a plate spring and/or a spacer element. The components of the torsional vibration damper and its compression spring serve to determine the properties of the torsional vibration damper.

Furthermore, the torsional vibration damper, for example its at least one flange part, can be in operative connection with a shaft of the electric machine. A torque or rotational energy can therefore be transferred from the torsional vibration damper to a shaft, wherein vibrations are ideally not transmitted further.

The active connection can be implemented as a form-fitting connection.

The at least one flange part of the torsional vibration damper can also have counter toothing.

In addition, the torsional vibration damper can be designed such that a rotor of the rotor device has a larger diameter than the torsional vibration damper. In other words, the torsional vibration damper can have a smaller diameter than a rotor of the rotor device. A compact design of the electric machine can thus be achieved.

Furthermore, the electric machine can have a shaft. This can be used to transmit the rotational energy or torque of the electric machine, but also the torque of an internal combustion engine.

The shaft can comprise a toothing into which at least one flange part of the torsional vibration damper engages with corresponding counter toothing.

The gearing and counter toothing can be designed with or without play.

Furthermore, the shaft, together with at least one flange part of the torsional vibration damper, can form a shaft-hub connection, using which a rotationally fixed connection between the torsional vibration damper and the shaft can be ensured.

In addition, the shaft can comprise a gear for transmitting rotational energy of the electric machine and/or an internal combustion engine to an intermediate shaft.

The shaft can also comprise a shiftable clutch in order to transfer rotational energy of the electric machine and/or an internal combustion engine to a gear of the shaft in a shiftable manner, such that an intermediate shaft can be supplied or not supplied with rotational energy.

The electric machine can also have a bearing with which the shaft is mounted on the housing.

Furthermore, the rotor device can have a rotor and a rotor carrier, which are connected to one another in a rotationally fixed manner. In addition to the electromagnetic coupling of the electric machine, the rotor of the electric machine serves as the primary flywheel mass inertia in order to reduce the rotational irregularities/torque fluctuations of an internal combustion engine before they are introduced into the torsional vibration damper, such that it can have a lower damper capacity. This can also be designed as an internal rotor.

The rotor, viewed in the radial direction, can be arranged on the outside of the rotor carrier, wherein the rotor carrier, viewed in the radial direction, can have a bearing seat for a bearing on the inside, with which forces of the rotor device can be absorbed, conveyed to the housing and together with a bearing, the rotation of the rotor device can be ensured. The rotor can have magnetized elements, magnets and/or coils.

Furthermore, the rotor device can comprise a bearing which is arranged on the bearing seat of the rotor carrier. With this, forces of the rotor device can be absorbed and the rotation of the rotor device can be ensured.

In addition, the at least one outer housing wall part can be designed to arrange the stator device.

The stator device can comprise a stator and a stator carrier, to which the stator is fastened radially on the inside and which is arranged radially on the outside on the at least one housing wall part. The stator can have magnetized elements, magnets and/or coils.

A cooling channel can be formed between the stator support and the at least one housing wall part in order to dissipate operating heat of the stator.

The stator carrier can be designed similarly to a hollow cylinder.

The stator carrier can also have at least one shoulder with which it rests against a shoulder of the at least one outer housing wall part.

The stator carrier can also have one or multiple grooves on the radial outside for attaching sealing elements, such that a cooling channel can be sealed in the axial direction. Furthermore, the stator carrier can comprise sealing elements which are arranged in its grooves.

The stator carrier can also have at least one passage, for example running in the axial direction, which is arranged on the outside when viewed in the radial direction in order to connect the stator carrier or stator carrier and sealing element of the sealing device to the at least one outer housing wall part.

The at least one passage can be formed on a shoulder with which the stator carrier rests against a shoulder of the at least one outer housing wall part.

The at least one outer housing wall part can comprise at least one internal thread, into which a screw is screwed in order to fasten the stator carrier or stator carrier and sealing element of the sealing device to the housing.

Furthermore, the stator carrier can have a chamfer at an axial end or at one end, viewed in the axial direction, on which a seal is arranged between the stator carrier and the sealing device or its sealing element. This can increase the sealing performance.

Finally, it should be mentioned that the electric machine is designed to generate electrical energy and to generate torque for a hybrid vehicle, for example to charge a battery and/or to supply energy to an electric motor and/or a combustion motor and/or to move a vehicle.

Furthermore, it should be noted that the axis of a passage or a through hole can run in the axial direction.

A second aspect of the present disclosure comprises a drive unit for a hybrid vehicle.

It is expressly noted that the features of the electric machine as mentioned in the first aspect of the disclosure can find application in the drive unit for a hybrid vehicle, both individually or in combination with one another.

In other words, the features mentioned above under the first aspect of the disclosure relating to the electric machine can also be combined with further features under the second aspect of the disclosure.

A drive unit for a hybrid vehicle comprises an electric machine according to the first aspect and an internal combustion engine with a crankshaft and a flexible disk part. Of course, the hybrid drive can also have a further, second electric machine in addition to the electric machine or first electric machine, wherein the first electric machine is used, for example, as a generator or as a drive and the further, second electric machine is used as a drive for a hybrid vehicle. The drive unit can be designed as a so-called serial drive, in which one electric machine works as a generator and the other works as a drive for a hybrid vehicle. However, it is also possible for the drive unit to be designed as a so-called parallel drive, in which an electric machine and an internal combustion engine work as a drive and another electric machine also works as a drive for a hybrid vehicle.

The flexible disk part can be connected to the crankshaft in a rotationally fixed manner and connected to a connecting part of the safety clutch of the electric machine in a rotationally fixed manner such that the rotational energy of the internal combustion engine can be transmitted via the crankshaft, the flexible disk part and the connecting part to a hub part of the rotor device and via a rotor carrier of the rotor device to a rotor of the rotor device or vice versa, for example to convert mechanical energy into electrical energy or electrical energy into mechanical energy.

The flexible disk part can be attached to the crankshaft using screws.

A mass part in the form of a ring can also be arranged between the connecting part of the rotor device and the flexible disk part. The mass part can therefore be arranged as an additional mass inertia to the safety clutch and rotor of the rotor device, for example, if required.

Furthermore, the flexible disk part can have at least one passage on its outside, viewed in the radial direction outwards, or on its radial outside, through which a screw can be passed in order to connect the flexible disk part to the connecting part of the rotor device of the electric machine.

Furthermore, the electric machine or the first electric machine can have a shaft. Here, the shaft can comprise a gear for transmitting rotational energy of the electric machine and/or an internal combustion engine to an intermediate shaft.

Furthermore, the drive unit can have a further electric machine for driving a hybrid vehicle or a second electric machine.

The further electric machine can comprise a shaft with toothing for engagement in a gear of an intermediate shaft.

In addition, the drive unit can comprise an intermediate shaft, with which rotational energy of the electric machine, the further electric machine and an internal combustion engine can be combined and conducted to a differential for distributing the rotational energy to vehicle wheels.

The intermediate shaft can comprise a gear for transmitting rotational energy from the further electric machine to the intermediate shaft.

In addition, the intermediate shaft can comprise a shiftable clutch in order to transfer rotational energy from the further electric machine to the gear of the intermediate shaft in a shiftable manner, such that the intermediate shaft of the drive unit can be supplied or not supplied with rotational energy from the further electric machine.

The solutions shown above with a safety clutch, arranged in a dry space or in a first spatial section, and torsional vibration dampers, arranged in an oil space or in the second spatial section, wherein the spatial sections are sealed from one another by means of a sealing device, have for serial and parallel operation of a hybrid vehicle advantages over the prior art in terms of installation space, insulation effect of the torsional vibration damper including arrangement of the primary and secondary mass inertias, friction torque capacity of the safety clutch and simplified assembly.

In summary, it can be stated for the drive unit described above that it is suitable for serial and parallel drive of a hybrid vehicle with two electric machines, one of which can be used as a generator, for boosting and for starting the internal combustion engine and the other, another electric machine can be designed as a main driving machine, which can be decoupled in certain driving states to increase efficiency.

It should also be noted that the term “torque-proof” can also be understood as “torque-transmitting”.

### BRIEF DESCRIPTION OF THE DRAWINGS

The disclosure will be explained in more detail below using an exemplary embodiment in conjunction with associated drawings. In the schematic drawings:

FIGS. 1 and 2 show a sectional view of a transmission with two electric machines from the prior art, wherein FIG. 2 showing an enlarged view of a section of FIG. 1;

FIG. 3 shows a sectional view of another transmission with two electric machines from the prior art;

FIGS. 4 and 5 show a sectional view of a drive unit for a hybrid vehicle, wherein FIG. 5 shows an enlarged view of a part of the drive unit from FIG. 4;

FIG. 6 shows a sectional view of the electric machine from FIG. 5, but on both sides of the axis of rotation; and

FIGS. 7 and 8 each show a torque flow through the drive unit for a hybrid vehicle based on FIGS. 4 and 5.

### DETAILED DESCRIPTION

In the description below, the same reference signs are used for the same components.

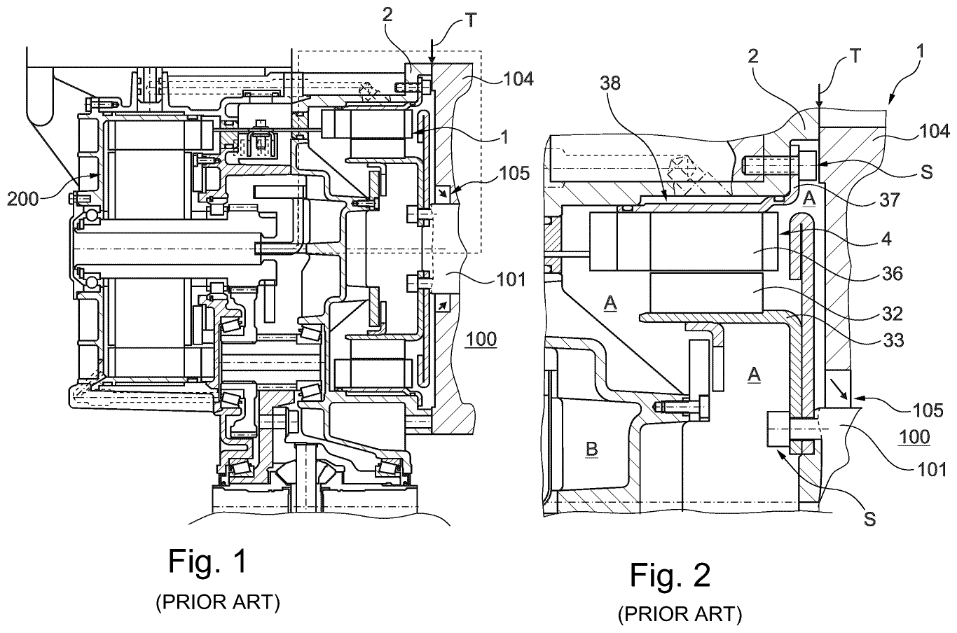

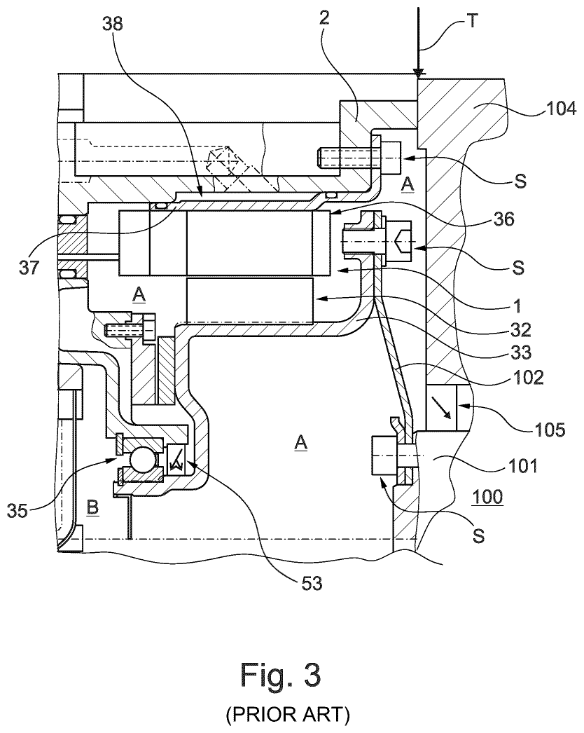

FIGS. 1 to 3 show sectional views of designs from the prior art, which were already discussed at the outset of this description, such that further explanations are omitted at this point.

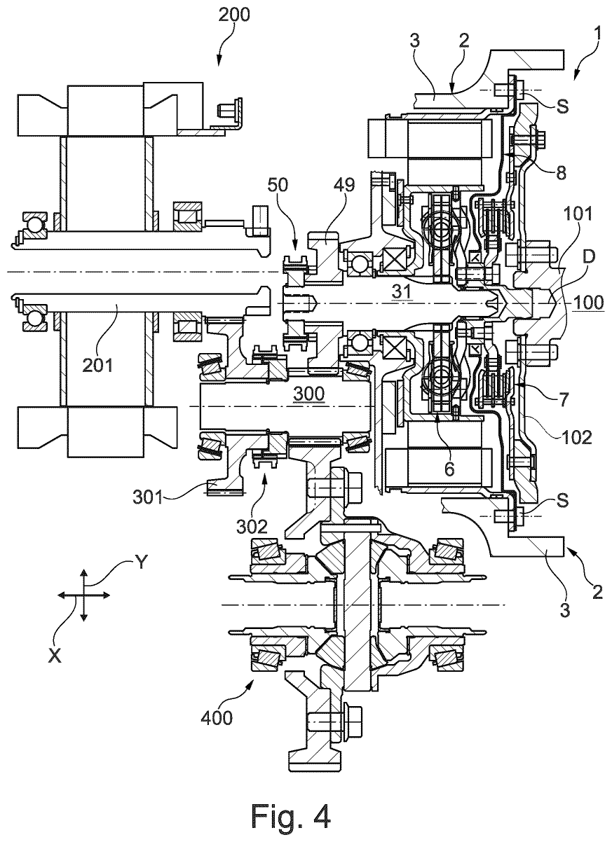

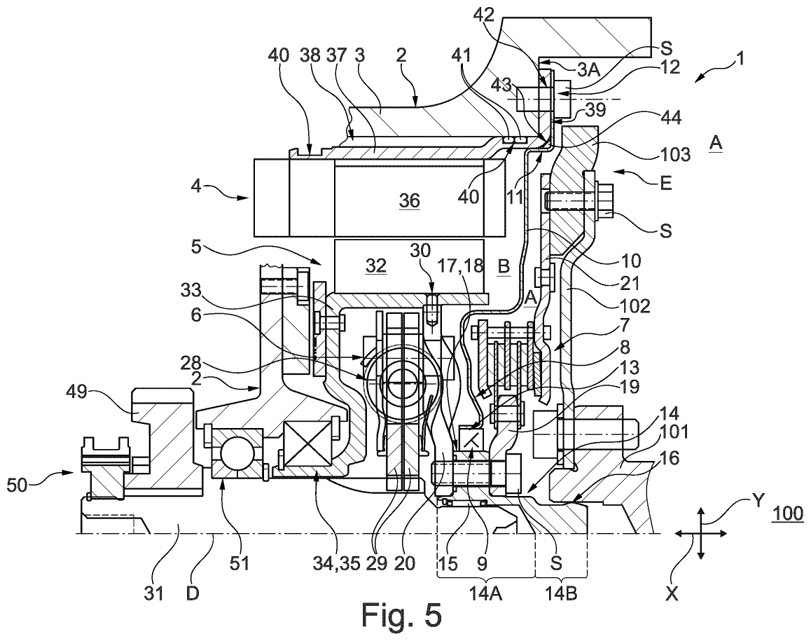

FIGS. 4 and 5 show a sectional view of a drive unit for a hybrid vehicle, wherein FIG. 5 shows an enlarged view of a part of the drive unit from FIG. 4.

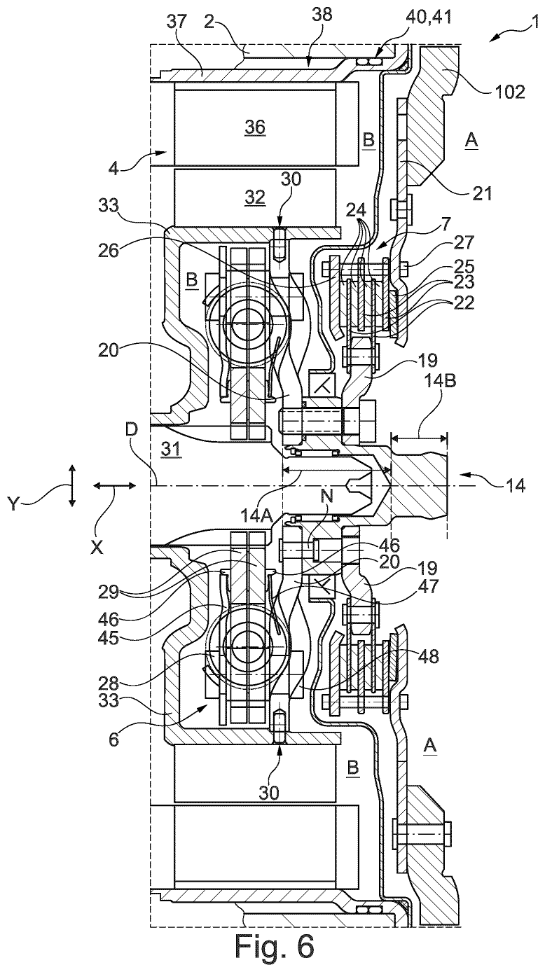

FIG. 6, on the other hand, shows a sectional view of the electric machine from FIG. 5, but on both sides of the axis of rotation D.

For the sake of simplicity and brevity, FIGS. 4 to 6 are described together below.

Said FIGS. 4 to 6 show a drive unit for a hybrid vehicle having an electric machine 1 for generating electrical energy and for generating torque for a hybrid vehicle. The drive unit additionally has a further electric machine 200 for driving a hybrid vehicle (see FIG. 4).

Furthermore, the drive unit comprises an internal combustion engine 100 (shown only as a reference sign) with a crankshaft 101 and a flexible disk part 102.

Furthermore, the drive unit has an intermediate shaft 300, with which rotational energy of the electric machine 1, the further electric machine 200 and the internal combustion engine 100 can be combined and conducted to a differential 400 for distributing the rotational energy to vehicle wheels (see FIG. 4).

Looking at FIGS. 5 and 6 it can be seen that the electric machine 1 for generating electrical energy and for generating torque for a hybrid vehicle has a housing 2 with an axial opening E for installing a stator device 4 and a rotor device 5. Furthermore, the electric machine 1 or its housing 2 has an outer housing wall part 3 with delimits the electric machine 1 relative to the environment.

In addition, the electric machine 1 comprises a stator device 4, which is arranged inside the housing 2. The electric machine 1 also has a rotor device 5 for connection to an internal combustion engine 100 such that rotational energy of the internal combustion engine 100 can be converted into electrical energy or rotational energy of the electric machine 1 can be conveyed to the internal combustion engine 100 or rotational energy of the electric machine 1 can be added to the rotational energy of the internal combustion engine 100.

Furthermore, FIGS. 5 and 6 show that the electric machine 1 has a torsional vibration damper 6 for damping torsional vibrations of the internal combustion engine 100.

In addition, the electric machine 1 has a torque-switching safety clutch 7 to prevent component-damaging torque differences between the electric machine 1 and the internal combustion engine 100.

According to FIG. 5, the electric machine 1 also has a sealing device 8, which seals the axial opening E of the housing 2 and subdivides the interior of the housing 2 in the axial direction X into two spatial sections A, B such that, in a first spatial section A, a crankshaft 101 of an internal combustion engine 100 can be connected to the rotor device 5 and, in a second spatial section, B the stator device 4 is arranged.

The torsional vibration damper 6 is arranged in one of the two spatial sections A, B and the safety clutch 7 is arranged in the other of the two spatial sections B, A. Strictly speaking, the torsional vibration damper 6 is arranged in the second spatial section B and the safety clutch 7 in the first spatial section A.

Returning to the sealing device 8, with the help of the arrangement presented, the sealing device 8 protects a stator 36 of the stator device 4 and a rotor 32 of the rotor device 5 from water and dirt. In addition, due to the sealing device 8, sealing the stator device 4 of the electric machine 1 is possible with simple effort. With the help of the sealing device 8, the electric machine 1 can also be tested in the factory before assembly with the internal combustion engine 100. As a result, a completely sealed and pre-tested electric machine 1 can be created, which can be tested with an internal combustion engine 100 before assembly and is protected against the ingress of water and/or dirt, even though the electric machine 1 has not yet been assembled with an internal combustion engine 100 or its housing.

As shown in FIGS. 5 and 6, the sealing device 8 is arranged inside the housing 2 and extends from the outer housing wall part 3 or from a stator carrier 37 of the stator device 4, e.g., in the radial direction Y inwards, towards the rotor device 5 or towards its hub unit 14.

The sealing device 8 lies sealingly on the stator carrier 37 of the stator device 4 and on the rotor device 5, in particular on a hub unit 14 of the rotor device 5.

Furthermore, FIG. 5 shows that the sealing device 8 has a radial shaft seal 9, which is arranged on a sealing surface 17 of a hub unit 14 of the rotor device 5.

The sealing device 8 has a shaped sealing element 10, the course of which is funnel-shaped, wherein the safety clutch 7 is arranged inside the funnel. The sealing element 10 forms at its end in the radial direction Y outwards or at its radially outer end a receptacle 11 for the stator carrier 37 of the stator device 4, wherein the sealing element 10 has multiple passages 12 for screws S or rivets at the radially outer end, such that a friction fitting or force-fitting connection between the sealing element 10 and the stator carrier 37 of the stator device 4 or also the housing 2 can be created. In this way, the sealing device 8 or the shaped sealing element 10 is arranged in a rotationally rigid manner on the stator carrier 37 of the stator device 4 and on the housing 2.

Furthermore, the sealing element 10 forms at its end in the radial direction Y inwards or at its radially inner end a receptacle 13 for the radial shaft seal 9 of the sealing device 8 and is designed such that the radial shaft seal 9 is tensioned with a preload force against a sealing surface 17 of a hub unit 14 of the rotor device 5.

As shown in FIGS. 4 and 5 and as already mentioned, the rotor device 5 has a hub unit 14, to which the torsional vibration damper 6 and the safety clutch 7 are each partially attached.

The hub unit 14, together with the sealing device 8, seals the axial opening E for installing the stator 4 and the rotor device 5, wherein the hub unit 14 is designed to accommodate a shaft 31 of the electric machine 1.

Furthermore, as shown in FIG. 5, the hub unit 14 is designed and configured in such a way that it is solid or impermeable in the area of the axis of rotation D of the electric machine 1, extends symmetrically about the axis of rotation D and further inwards in the radial direction Y is arranged as a rotor carrier 33 of the rotor device 5.

In addition, the hub unit 14 has a hollow cylindrical part 14A for receiving a shaft 31 of the electric machine 1 and a fully cylindrical part 14B for operative connection with the crankshaft 101 of the internal combustion engine 100 (see FIGS. 5 and 6). The hollow cylindrical part and the fully cylindrical part 14A, 14B are arranged one behind the other in the axial direction X.

The hollow cylindrical part 14A has on its inner surface a receptacle for a needle bearing 15 in order to support forces on a shaft 31 of the electric machine 1 and to enable a relative rotation of the hub unit 14 to this shaft 31.

The fully cylindrical part 14B has a bearing point 16 on its outer surface for bearing on an inner surface of the crankshaft 101 of the internal combustion engine 100 (see FIGS. 5 and 6).

According to FIG. 5, the hub unit 14 has a sealing surface 17 for the radial shaft seal 9 of the sealing device 8. The sealing surface 17 is arranged between a first driving part 19 of the rotor device 5 and a second driving part 20 of the rotor device 5. The sealing surface 17 is formed by a shoulder 18 of the hub unit 14.

In other words, as shown in FIG. 5, the hub unit 14 has a shoulder 18 against which a second driving part 20 of the rotor device 5 rests on one side and a first driving part 19 of the rotor device 5 rests on the other side, such that the crankshaft 101 of the internal combustion engine 100 is connected to a rotor carrier 33 of the rotor device 5 via the driving parts 19, 20 and via the hub unit 14. The shoulder 18 projects outwards in the radial direction Y.

The shoulder 18 has multiple axially extending through holes, in each of which a rivet N or a screw S is arranged, which connect the hub unit 14 and a first driving part 19 and a second driving part 20 of the rotor device 5 to one another in a rotationally fixed manner (see FIGS. 5 and 6).

As also shown in FIGS. 5 and 6 and as already indicated several times, the rotor device 5 has a first driving part 19, with which the safety clutch 7 is arranged on the rotor device 5, and a second driving part 20, with which the torsional vibration damper 6 is arranged on the rotor device 5.

Looking at FIG. 6, it is shown that the safety clutch 7 comprises an output with which the safety clutch 7 is arranged on the hub unit 14 of the rotor device 5, wherein the output is formed by the first driving part 19 of the rotor device 14.

In addition, the safety clutch 7 has an input 21, which is formed by a connecting part 21 with which the safety clutch 7 is connected to the crankshaft 101 of the internal combustion engine 100.

The safety clutch 7 is designed such that when a certain torque is exceeded, the input and the output can be rotated relative to one another.

The radial inside of the connecting part 21 forms the input to the torque-switching safety clutch 7 and thus a part of the torque-switching safety clutch 7.

The connecting part 21 has multiple internal threads on its radial outside for connection to the crankshaft 101 of the internal combustion engine 100.

In addition, it can be seen from FIG. 6 that the safety clutch 7 comprises multiple first friction elements 22, which are connected in a rotationally fixed manner to the first driving part 19, and multiple second friction elements 23, which are connected in a rotationally fixed manner to the connecting part 21.

Friction linings 24 are arranged between the first and second friction elements 22, 23. In addition, the safety clutch 7 has a plate spring 25 as an axial energy store in order to apply a normal force to the first and second friction elements 22, 23 and to the friction linings 24 and thus generate a definable friction torque.

Furthermore, the safety clutch 7 has a counterplate 26 and multiple spacer elements 27 for axially spacing the counterplate 26 from the connecting part 21. The first and second friction elements 22, 23, the plate spring 25 and the friction linings 24 are arranged between the counterplate 26 and the connecting part 21 in order to transmit a torque.

As shown in FIG. 6, the torsional vibration damper 6 has a compression spring 28, an input 20 and two flange parts 29 as an output to a shaft 31 of the electric machine 1.

The input 20 is formed by the second driving part 20 of the rotor device 5, wherein the compression spring 28 receives a torque from the second driving part 20 and conveys it to the flange parts 29.

The input of the torsional vibration damper 6 or the second driving part 20 is arranged in a rotationally secure manner on a rotor carrier 33 of the rotor device 5 by means of various dowel pins 30.

The torsional vibration damper 6 also has a counter disk part 45, multiple friction ring parts 46, a plate spring 47 and multiple spacer elements 48.

As can be seen in FIG. 6, the flange parts 29 are in operative connection with a shaft 31 of the electric machine 1, wherein the operative connection is implemented as a form-fitting connection. In other words, the flange parts 29 of the torsional vibration damper 6 have counter toothing.

As already indicated several times, the electric machine 1 has a shaft 31. Here, the shaft 31 has teeth into which the flange parts 29 of the torsional vibration damper 6 engage with corresponding counter toothing. The toothing and counter toothing are designed to with or without play.

Described more specifically, the shaft 31 together with the flange parts 29 of the torsional vibration damper 6 forms a shaft-hub connection, with the help of which a rotationally fixed or torque-transmitting connection between the torsional vibration damper 6 and shaft 31 is ensured.

As FIG. 5 shows, the shaft 31 also has a gear 49 for transmitting rotational energy of the electric machine 1 and the internal combustion engine 100 to the intermediate shaft 300 (see FIG. 4).

The shaft 31 comprises a shiftable clutch 50 in order to transfer rotational energy of the electric machine 1 and the internal combustion engine 100 to the gear 49 of the shaft 31 in a shiftable manner, such that the intermediate shaft 300 can be supplied or not supplied with rotational energy.

In addition, it can be seen from FIG. 5 that the electric machine 1 has a bearing 51 with which the shaft 31 is mounted on the housing 2.

Also already mentioned several times, according to FIGS. 5 and 6, the rotor device 5 has a rotor 32 and a rotor carrier 33, which are connected to one another in a rotationally fixed manner. The rotor 32, viewed in the radial direction Y, is arranged on the outside of the rotor carrier 33, which, viewed in the radial direction Y, has a bearing seat 34 for a bearing 35 on the inside. With the help of the bearing seat 34, forces of the rotor device 5 can be absorbed and conveyed to the housing 2.

Also, as shown in FIG. 5, the rotor device 5 has a bearing 35 which is arranged in the bearing seat 34 of the rotor carrier 33 in order to ensure the rotation of the rotor device 5 relative to the housing 2.

According to FIG. 5, the outer housing wall part 3 is designed to arrange the stator device 4, wherein the stator device 4 has a stator 36 and a stator carrier 37. The stator 36 is fastened to the stator carrier 37 on the radial inside and the stator carrier 37 is arranged on the housing wall part 3 on the radial outside.

A cooling channel 38 is formed between the stator carrier 37 and the housing wall part 3 in order to dissipate operating heat from the stator 36.

FIG. 5 also shows that the stator carrier 37 is designed similar to a hollow cylinder and that it has a shoulder 39 with which the stator carrier 37 lies on a shoulder 3A of the outer housing wall part 3.

In addition, it can be seen in FIG. 5 that the stator carrier 37 has multiple grooves 40 on the radial outside for attaching sealing elements 41 and multiple sealing elements 41, such that the cooling channel 38 can be sealed in the axial direction X using the sealing elements 41.

Furthermore, FIG. 5 shows that the stator carrier 37 has various passages 42, which are arranged on the outside as viewed in the radial direction Y in order to connect the stator carrier 37 to the outer housing wall part 3.

The passages 42 are formed on the shoulder 39, with which the stator carrier 37 rests against the shoulder 3A of the outer housing wall part 3.

The outer housing wall part 3 has multiple internal threads, into each of which a screw S is screwed in order to fasten the stator carrier 37 to the housing 2.

FIG. 5 also shows that the stator carrier 37 has a chamfer 43 at one axial end, on which a seal 44 is arranged between the stator carrier 37 and the sealing device 8 or its sealing element 10.

With a view to FIGS. 4 to 6, the drive unit for a hybrid vehicle comprises the electric machine 1 and the internal combustion engine 100 with the crankshaft 101 and the flexible disk part 102.

The flexible disk part 102 is connected to the crankshaft 101 in a rotationally fixed manner and connected to the connecting part 21 of the safety clutch 7 of the electric machine 1 in a rotationally fixed manner such that rotational energy of the internal combustion engine 100 can be transmitted via the crankshaft 101, the flexible disk part 102 and the connecting part 21 to the hub part 14 of the rotor device 5 and via the rotor carrier 33 to a rotor 32 of the rotor device 5 or vice versa. This means, for example, that mechanical energy can be converted into electrical energy or electrical energy can be converted into mechanical energy.

A mass part 103 in the form of a ring is arranged between the connecting part 21 of the rotor device 5 and the flexible disk part 102. This causes the mass part 103 to serve as additional mass inertia.

Furthermore, the flexible disk part 102 is fastened to the crankshaft 101 by means of screws S, wherein the flexible disk part 102 comprises passages on its radial outside through which screws S are passed in order to connect the flexible disk part 102 to the connecting part 21 of the rotor device 5 and the mass part 103.

As already indicated, the electric machine 1 has a shaft 31, which comprises a gear 49 for transmitting rotational energy of the electric machine 1 and an internal combustion engine 100 to the intermediate shaft 300.

In addition—as already mentioned—the drive unit has a further electric machine 200 for driving a hybrid vehicle, which comprises a shaft 201 with toothing for engagement in a gear 301 of the intermediate shaft 300 (see FIG. 4).

With the help of the intermediate shaft 300 of the drive unit, rotational energy of the electric machine 1, the further electric machine 200 and the internal combustion engine 100 can be combined and conducted to a differential 400 for distributing the rotational energy to vehicle wheels.

Thus, according to FIG. 4—as already indicated—the intermediate shaft 300 has a gear 301 for transmitting rotational energy from the further electric machine 200 to the intermediate shaft 300.

The intermediate shaft 300 also has a shiftable clutch 302 in order to transfer rotational energy from the further electric machine 200 to the gear 301 of the intermediate shaft 300 in a shiftable manner, such that the intermediate shaft 300 of the drive unit can be supplied or not supplied with rotational energy from the further electric machine 200.

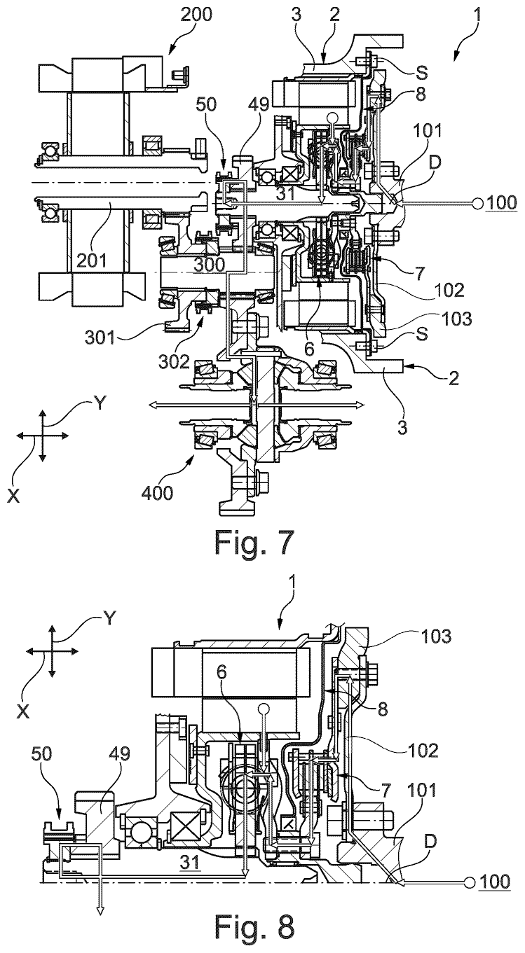

FIGS. 7 and 8 each show a torque flow through the drive unit for a hybrid vehicle based on FIGS. 4 and 5.

Described in more detail, FIGS. 7 and 8 illustrate the flow of force/torque from the internal combustion engine 100 or the electric machine 1 to a differential 400.

The force or torque of the internal combustion engine 100 is transferred from the crankshaft 101 into the flexible disk part 102 or flexplate 102 via the mass part 103, which is used or can be omitted as required for the corresponding application, in the connecting part 21 of the safety clutch 7. As already described, the disk part 102 and mass part 103 are detachably connected to each other via a detachable connection, e.g., a screw connection, and in the continuation, the mass part 103 and connecting part 21 are connected to each other via suitable connecting elements, e.g., rivets or screws S. If the mass part 103 is omitted, the detachable connection must be carried out directly between the disk part 102 and the connecting part 21 (not shown). A detachable connection is required at this point in order to be able to easily assemble the internal combustion engine 100 and the electric machine 1 or disassemble them for servicing.

From the safety clutch 7, the force/torque is conveyed via the first driving part 19 to the hub unit 14 of the rotor device 5 and, in its continuation, to the second driving part 20 of the rotor device 5.

The first driving part 19, the hub unit 14 arranged therebetween and the second driving part 20 are connected to each other in a torque-proof manner via a detachable connection, e.g., via screws S. The hub unit 14 and driving parts 19, 20 can also be connected to each other in a torque-proof manner using suitable connecting elements, e.g., rivets, and arranged at a different position on the circumference than the screws S (see FIG. 6).

The force or torque of the electric machine 1 is introduced into the second driving part 20 of the rotor device 5 in the radially outer region of the rotor carrier 33. The transmission between the rotor carrier 33 into the second driving part 20 takes place in a torque-proof and play-free manner, e.g., via radially arranged dowel pins 30 or other suitable connecting elements.

From the torsional vibration damper 6, the force/torque is conveyed via the flange parts 29 of the torsional vibration damper 6 to the shaft 31 by means of a toothing. In the damper variant shown here in the two-flange part design, this toothing ensures the clearance angle required on the tension and thrust sides to ensure the damper function. Not shown here, but possible in principle and also applicable to other types of dampers, a transition element between flange part 29 and shaft 31 in the form of a damper hub known from the prior art is conceivable.

The force/torque of the electric machine 1 is transferred from the shaft 31 via the clutch 50 and the gear 49 to the intermediate shaft 300. The transfer to the differential 400 takes place from the intermediate shaft 300.

The figures are described again below in other words.

FIGS. 4 and 5 show a drive unit with two electric machines 1, 200, having a slip clutch 7 or safety clutch 7, having a damper 6 or torsional vibration damper 6 and having a seal 8 or a sealing device 8.

The safety clutch 7 and the torsional vibration damper 6 are designed such that the rotor 32 of the rotor device 5 has a larger diameter than the safety clutch 7 and the torsional vibration damper 6.

According to FIGS. 4 and 5, the internal combustion engine 100 is connected to the electric machine 1 in a torque-proof manner. In the torque flow between the internal combustion engine 100/the electric machine 1 and the drive shaft 31 or shaft 31, the slip clutch 7 or the safety clutch 7 are interposed as an overload protection element and the damper 6 or the torsional vibration damper 6 for vibration isolation.

In addition to the electromagnetic coupling of the electric machine, the rotor 32 of the electric machine 1 serves as the primary flywheel mass inertia in order to reduce the rotational irregularities/torque fluctuations of the internal combustion engine 100 before they are introduced into the torsional vibration damper 6, such that it can have a lower damper capacity.

Overload/impact torque that can come from both a wheel and the internal combustion engine 100 are effectively reduced with the help of the safety clutch 7 in order to protect the torsional vibration damper 6 and the other components of the drive train from damage.

FIG. 5 shows an enlarged image of how the arrangement of the safety clutch 7 and the torsional vibration damper 6 is in terms of the best possible use of installation space, since the safety clutch 7 and the torsional vibration damper 6 have a smaller diameter than the rotor 32 of the rotor device 5.

The electric machine 1 is located with its stator device 4 or stator 36 and stator carrier 37 as well as with its rotor device 5 or rotor 32 and rotor carrier 33 in the oil space/second spatial section B. If required, an encoder wheel of a rotor-bearing sensor can be arranged next to the rotor 32, which is connected to the housing 2, e.g., via a screw connection.

The first and second spatial sections A, B or drying space A and oil space B are sealed against each other. The sealing helps ensure prevent, on the one hand, water from entering the electric machine 1 and, on the other hand, oil escaping from the electric machine 1. For this purpose, the electric machine 1 has the sealing device 8 with a sealing element 10, which is located axially between the electric machine 1 and the internal combustion engine 100. The sealing element 10 subdivides the interior of the housing 2 in the axial direction X into two spatial sections A, B (dry space A and oil space B). In addition, there is a seal 44 (e.g., made of an elastomeric material) between the sealing element 10 and the stator carrier 37 in a position arranged radially above the electric machine 1 for sealing from the outside. At the radially inner end of the sealing element 10, the sealing device 8 has a radial shaft seal 9, which provides sealing on the inside.

The design of a drive unit presented above enables the safety clutch 7 to be arranged in the first spatial section A. The torsional vibration damper 6 is arranged in the oil space or in the second spatial section B, which has additional advantages in terms of damper service life, since the contact elements within the damper or the torsional vibration damper 6 supplied with lubricant and thus wear can be reduced.

The rotor carrier 33 is supported together with the torsional vibration damper 6 by means of rotor bearings or bearings 35 in the housing 2.

The shaft 31 of the electric machine 1 is supported on the one hand axially next to the described bearing 35 in the housing 2 with the bearing 51 and on the other hand with a needle bearing 15 radially below the torsional vibration damper 6 and the safety clutch 7. In axial continuation in the direction of the internal combustion engine 100, the shaft 31 is supported via the hub unit 14 or its fully cylindrical part 14B in the crankshaft 101 via the bearing point 16.

This embodiment of the bearing point 16 in the crankshaft 101 is common, for example, when using torque converters or wet dual clutches in automatic transmissions. In the solution described here, the bearing point 16 only experiences a relative movement between the crankshaft 101 and the hub unit 14 if the safety clutch 7 slips in the event of an overload. Otherwise, there is no relative movement between the crankshaft 101 and the hub unit 14.

The needle bearing 15 in turn always experiences a relative movement between the hub unit 14 and the shaft 31 when the torsional vibration damper 6 is rotated on the tension and shear sides within its defined torsion characteristic curve. Otherwise, the needle bearing 15 rotates at the absolute speed of the hub unit 14 and the shaft 31 and thus ultimately of the internal combustion engine 100 and the electric machine 1.

FIGS. 5 and 6 show an enlarged section of the drive train, which essentially shows the installation space of the safety clutch 7 and the torsional vibration damper 6 radially below the rotor 33 of the electric machine 1 as well as its main components and interfaces and the axially arranged sealing device 8 and the seal 44.

The second friction elements 23 of the safety clutch 7, together with the counterplate 26, take over the torque from the connecting part 21 and spacer element 27 via a suitable connection, e.g., a toothing, and convey this to the friction linings 24 and these in turn to the first friction elements 22. The second friction elements 22 transfer the torque to the first driving part 19 via a suitable connection, e.g., a driving rivet.

The plate spring 25 of the safety clutch 7 serves as an axial energy store in order to apply the required normal force to the friction surfaces of the friction linings 24 and thus generate the friction torque.

The components of the safety clutch 7 are enclosed by the counterplate 26 and the connecting part 21 and held axially in position by the spacer elements 27.

Due to the position of the safety clutch 7 radially below the rotor carrier 33, it proves to be advantageous in the present exemplary embodiment to double the number of friction linings (2 pieces), contrary to the usual number for applications in the dry space or in the first sectional section A, in order to compensate for the loss of frictional torque (due to the reduction of the effective friction radius) by providing additional friction surfaces.

More than the four friction linings shown here are also conceivable, although the number of first and second friction elements 22, 23 also increases accordingly.

In summary, the result is a compact safety clutch 7 with a corresponding friction torque capacity which can be adapted to the corresponding application via the number of friction surfaces, the plate spring force and other design criteria. For applications with reduced torque, a solution with a reduced number of friction linings is conceivable.

The interface between the safety clutch 7 and the torsional vibration damper 6 takes place via a suitable connection, e.g., by means of screws S, which connect the first driving part 19, the hub unit 14 arranged therebetween and the second driving part 20 with one another in a torque-proof manner.

In the area of this interface at the radially outer end of the hub unit 14 is the contact surface or sealing surface 17 for the radial shaft seal 9, which fulfills the inward sealing function.

Furthermore, in the area of the screw S at the axial connection point between the hub unit 14 and the second driving part 20, a sealing ring 52 is arranged in accordance with the number of screws used, which additionally supports the sealing on the inside if necessary. This sealing ring 52 can be designed as an O-ring and prevents fluid from entering or exiting in the gap area between the hub unit 14 and the second driving part 20 (see FIG. 6). A sealing ring in the area of the rivet N is also conceivable in principle, but not shown here.

The input of the torsional vibration damper 6 is formed by the second driving part 20, which, together with the counter disk part 45, spaced apart via various spacer elements 48, encloses the components of the torsional vibration damper 6 and holds them axially in position.

The known damper components, as already described, are arranged within the torsional vibration damper 6 between the second driving part 20 and the counter disk part 45, wherein the specific number and placement of the components depends on the respective damper type and the insulation requirements, which will not be discussed in more detail here.

The output of the torsional vibration damper 6 forms the flange parts 29, which are connected to the shaft 31 in a torque-proof manner via a toothing with or without play, depending on the damper variant.

The outer area of the second driving part 20 centers the torsional vibration damper 6 in the rotor carrier 33 and holds it in the axial position. The connection is made via the dowel pins 30 shown, which are mounted radially from the outside of the rotor carrier 33.

In the embodiment described here, both safety clutch 7 and torsional vibration damper 6 can be constructed separately, i.e., independently of one another, during assembly and connected to one another in final assembly.

Furthermore, with this solution there is the possibility of combining different versions of safety clutch 7 and torsional vibration damper 6 depending on the application, almost like in a modular system, while maintaining the interfaces between safety clutch 7 and torsional vibration damper 6.

In addition to the possibility of standardizing the components and assembly processes, this also contributes to the cost benefit of this solution.

FIGS. 5 and 6 also show the area of the bearing of the shaft 31 and the hub unit 14.

The bearing 35 is held axially in position on the housing side on its outer ring via the axial stop area and a securing element. On an inner ring, the axial support takes place on the rotor carrier 33 on one side and on a securing element on the opposite side.

The shaft 31 is mounted on the housing side on an outer ring of the bearing 51 via an axial stop area of the housing 2 and a securing element. On an inner ring, the axial support takes place on one side on the axial stop of the shaft 31 and on the opposite side on a securing element. This results in a fixed bearing position for the bearing 51.

The shaft 31 is supported on the internal combustion engine side via the needle bearing 15 described above. This needle bearing 15 is held axially in position on the hub unit 14 via an axial stop and on the other side via a snap ring.

The outer area of the shaft 31 can be made crowned in the contact area with the rolling elements of the needle bearing 15 in order to compensate for axial offset and misalignment between the crankshaft 101 and shaft 31, such that no impermissible additional loads arise on other components. Furthermore, a radial play in the order of 0 . . . 0.3 mm is nominally foreseeable in this contact area.

The needle bearing 15 forms a floating bearing.

At the bearing point 16 between the crankshaft 101 and the hub unit 14, a radial play in the order of 0 . . . 0.5 mm is also nominally foreseeable.

### List of Reference Signs

1 Electric machine
2 Housing
3 Housing wall part
3A Shoulder
4 Stator device
5 Rotor device
6 Torsional vibration damper
7 Safety clutch
8 Sealing device
9 Radial shaft seal
10 Sealing element
11 Receptacle
12 Passage
13 Receptacle
14 Hub unit
14A Hollow cylindrical part
14B Fully cylindrical part
15 Needle bearing
16 Bearing point
17 Sealing surface
18 Shoulder
19 First driving part
20 Second driving part
21 Connecting part
22 First friction element
23 Second friction element
24 Friction lining
25 Plate spring
26 Counterplate
27 Spacing element
28 Compression spring
29 Flange part
30 Dowel pin
31 Shaft
32 Rotor
33 Rotor carrier
34 Bearing seat
35 Bearing
36 Stator
37 Stator carrier
38 Cooling channel
39 Shoulder
40 Slot
41 Sealing element
42 Passage
43 Chamfer
44 Seal
45 Counter disk part
46 Friction ring part
47 Plate spring
48 Spacing element
49 Gear
50 Clutch
51 Bearing
52 Sealing ring
53 Radial shaft seal
100 Internal combustion engine
101 Crankshaft
102 Flexible disk part
103 Mass part
104 Housing
105 Radial shaft seal
200 Further electric machine
201 Shaft
300 Intermediate shaft
301 Gear
302 Clutch
400 Differential
X Axial direction
Y Radial direction
E Opening
N Rivet
S Screw
T Parting plane
A First spatial section
B Second spatial section

1. An electric machine for generating electrical energy and for generating torque for a hybrid vehicle, the electrical machine comprising:
a housing having an axial opening for installing a stator and a rotor device and having at least one outer housing wall part which delimits the electric machine relative to the environment;
the stator arranged inside the housing;
the rotor device is adapted for connection to an internal combustion engine, such that at least one of a) rotational energy of the internal combustion engine is convertible into electrical energy, b) rotational energy of the electric machine is conveyable to the internal combustion engine, or c) rotational energy of the electric machine is addable to the rotational energy of the internal combustion engine;
a torsional vibration damper configured to damp torsional vibrations of the internal combustion engine;
a torque-switching safety clutch configured to prevent component-damaging differences in torque between the electric machine and the internal combustion engine;
a sealing device that seals the axial opening of the housing and subdivides an interior of the housing into first and second spatial sections in an axial direction, such that in the first spatial section a crankshaft of the internal combustion engine is connectible to the rotor device and the stator is arranged in the second spatial section; and
the torsional vibration damper in arranged in one of the two spatial sections and the safety clutch is arranged in the other of the two spatial sections

2. The electric machine according to claim 1, wherein at least one of the sealing device is arranged inside the housing and extends from the at least one outer housing wall part or from a stator carrier of the stator towards the rotor device, or the sealing device lies sealingly on the at least one outer housing wall part or on the stator carrier of the stator and on the rotor device.

3. The electric machine according to claim 1, wherein the sealing device comprises a radial shaft seal and a shaped sealing element, a course of which is funnel-shaped, and the sealing element forms a receptacle at a radially inner end thereof for a radial shaft seal of the sealing device and is designed such that the radial shaft seal has a preload force against a sealing surface of a hub unit of the rotor device.

4. The electric machine according to claim 1, wherein the rotor device has a hub unit to which the torsional vibration damper and the safety clutch are each partially attached, and the hub unit together with the sealing device seals the axial opening for installing the stator and the rotor device, and the hub unit is designed to accommodate a shaft of the electric machine.

5. The electric machine according to claim 1, wherein the rotor device comprises a first driving part, with which the safety clutch is arranged on the rotor device.

6. The electric machine according to claim 1, wherein the safety clutch comprises an output with which the safety clutch is arranged on a hub unit of the rotor device, the output is formed by a first driving part of the rotor device, and the safety clutch has an input which is formed by a connecting part with which the safety clutch is connectable to a crankshaft of the internal combustion engine.

7. The electric machine according to claim 1, wherein the torsional vibration damper comprises at least one compression spring, an input and at least one flange part as an output to a shaft of the electric machine, the input is formed by a second driving part of the rotor device, the at least one compression spring receives a torque from the second driving part and conveys the torque to the at least one flange part, and the input of the torsional vibration damper is arranged in a rotationally secure manner on a rotor carrier of the rotor device by one or more dowel pins.

8. The electric machine according to claim 1, wherein the rotor device has a rotor and a rotor carrier which are connected to one another in a rotationally fixed manner, and the rotor, viewed in a radial direction, is arranged on an outside of the rotor carrier, and the rotor carrier, viewed in the radial direction, has a bearing seat for a bearing on an inside, with which forces of the rotor device are adapted to be absorbed, conveyed to the housing and rotation of the rotor device (5) ensured.

9. A drive unit for a hybrid vehicle, the drive unit comprising:
the electric machine according to claim 1, and
an internal combustion engine having a crankshaft and a flexible disk part,
wherein the flexible disk part is connected to the crankshaft in a rotationally fixed manner and connected to a connecting part of the safety clutch of the electric machine in a rotationally fixed manner such that rotational energy of the internal combustion engine transmittable via the crankshaft, the flexible disk part and the connecting part to a hub part of the rotor device and via a rotor carrier of the rotor device to a rotor of the rotor device or vice versa, in order to at least one of convert mechanical energy into electrical energy or electrical energy into mechanical energy.

10. The drive unit according to claim 9,
wherein the electric machine has a shaft, the shaft comprises a gear for transmitting rotational energy of at least one of the electric machine or the internal combustion engine to an intermediate shaft, and the drive unit has a further electric machine for driving a hybrid vehicle, the further electric machine comprises a shaft with toothing for engagement in a gear of the intermediate shaft,
wherein the drive unit comprises the intermediate shaft, with which rotational energy of the electric machine, the further electric machine and the internal combustion engine are combinable and conducted to a differential for distributing the rotational energy to vehicle wheels, and the intermediate shaft comprises the gear for transmitting rotational energy of the further electric machine to the intermediate shaft.

11. The electric machine according to claim 1, wherein the rotor device has a hub unit to which the torsional vibration damper and the safety clutch are each partially attached, the hub unit has a sealing surface for a radial shaft seal of the sealing device, and the sealing surface is arranged between a first driving part of the rotor device and a second driving part of the rotor device.

12. The electric machine according to claim 1, wherein the rotor device comprises a second driving part, with which the torsional vibration damper is arranged on the rotor device.

13. An electric machine for generating electrical energy and for generating torque for a hybrid vehicle, the electrical machine comprising:
a housing having an axial opening for installing a stator and a rotor device;
the stator arranged inside the housing;
the rotor device is adapted for connection to an internal combustion engine, such that at least one of a) rotational energy of the internal combustion engine is convertible into electrical energy, b) rotational energy of the electric machine is conveyable to the internal combustion engine, or c) rotational energy of the electric machine is addable to the rotational energy of the internal combustion engine;
a torsional vibration damper configured to damp torsional vibrations of the internal combustion engine connected to the rotor device;
a torque-switching safety clutch configured to prevent component-damaging differences in torque between the electric machine and the internal combustion engine;
a sealing device that seals the axial opening of the housing and subdivides an interior of the housing into first and second spatial sections in an axial direction, such that in the first spatial section a crankshaft of the internal combustion engine is connectible to the rotor device and the stator is arranged in the second spatial section; and
the torsional vibration damper in arranged in the first spatial section and the safety clutch is arranged in the second spatial section.

14. The electric machine according to claim 13, wherein at least one of the sealing device is arranged inside the housing and extends from at least one outer housing wall part or from a stator carrier of the stator towards the rotor device, or the sealing device lies sealingly on at least one outer housing wall part or on the stator carrier of the stator and on the rotor device.

15. The electric machine according to claim 13, wherein the sealing device comprises a radial shaft seal and a shaped sealing element, a course of which is funnel-shaped, and the sealing element forms a receptacle at a radially inner end thereof for a radial shaft seal that has a preload force against a sealing surface of a hub unit of the rotor device.

16. The electric machine according to claim 13, wherein the rotor device has a hub unit to which the torsional vibration damper and the safety clutch are each partially attached, and the hub unit together with the sealing device seals the axial opening for installing the stator and the rotor device, and the hub unit is designed to accommodate a shaft of the electric machine.

17. The electric machine according to claim 13, wherein the rotor device comprises a first driving part, with which the safety clutch is arranged on the rotor device.

18. The electric machine according to claim 13, wherein the safety clutch comprises an output with which the safety clutch is arranged on a hub unit of the rotor device, the output is formed by a first driving part of the rotor device, and the safety clutch has an input which is formed by a connecting part with which the safety clutch is connectable to a crankshaft of the internal combustion engine.

19. The electric machine according to claim 13, wherein the rotor device has a hub unit to which the torsional vibration damper and the safety clutch are each partially attached, the hub unit has a sealing surface for a radial shaft seal of the sealing device, and the sealing surface is arranged between a first driving part of the rotor and a second driving part of the rotor.

20. The electric machine according to claim 13, wherein the rotor device comprises a second driving part, with which the torsional vibration damper is arranged on the rotor device.
